(19) United States
(12) Patent Application Publication
(10) Pub. No.: US 2007/0100741 A1
(43) Pub. Date: May 3, 2007

(54) Method and system for viewing auction information in a seller's product catalog in an internal auction system

(75) Inventors: Yan Cui, Sunnyvale, CA (US); Rowell Sotto, Mountain View, CA (US); Lenin K. Subramanian, Palo Alto, CA (US)

Correspondence Address: KENYON & KENYON LLP, 1500 K STREET N.W., WASHINGTON, DC, 20005, US

(73) Assignee: SAP AG

(21) Appl. No.: 11/591,148

(22) Filed: Oct. 31, 2006

Related U.S. Application Data
(60) Provisional application No. 60/732,666, filed on Nov. 3, 2005.

(51) Int. Cl. G06Q 40/00

(52) U.S. Cl. 705/37

(57) ABSTRACT

A customer may view auction information in an existing product catalog on a seller e-commerce site. The auction information may be integrated into the product catalog and may inform the customer about both existing auctions and the status of the auctions. For example, an icon may be displayed in the product entry in the product catalog indicated both an existing auction by the presence of the icon and the auction status by the type of icon used. The auction information may include a hyperlink allowing the customer to click on the auction information (e.g., the icon) to rapidly navigate the customer to the auction information. In this manner, a customer may be presented information in a seller e-commerce site from an internal auction system integrated with a product catalog from a seller business information management system.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a method and system for providing integrated auction services through a seller's e-commerce site. In particular, the present invention relates to viewing auction information and receiving auction notification in a seller's product catalog in an internal auction system.

### BACKGROUND

Businesses traditionally look for effective ways in which to make their products available to potential buyers. In addition to sales through physical “brick and mortar” stores, innovative ways to sell products are often used especially to dispose of old or excess inventory. The advent of the Internet along with the accompanying revolution in computer and network technology has created new sales paradigms and allowed businesses to establish their own electronic commerce (“e-commerce”) presence through the use of, for example, Internet Web sites. E-commerce sales have steadily grown and now account for a significant portion of business-to-consumer as well as business-to-business sales. Auctions make up a significant portion of e-commerce sales and have grown into an increasingly more important sales paradigm.

The revolution in network and computer capability along with the mass availability and development of the Internet facilitates alternative methods of sales such as auctions. Network-based electronic auctions, such as for example those conducted over the Internet, may allow a seller considerable control over an auction and may increase auction participation. For example, a seller may want to limit participation in the auction where the pool of potential customers is limited or where allowing an open auction may, in some manner, hinder the auction process. In another example where an auction may be open to all potential bidders it is often beneficial to maximize the number of people participating in the auction in order to extract the greatest price for the product or lot being auctioned. The Internet and network-based computing provide the ability to aggregate large numbers of bidders for an auction in an easier and generally less costly manner than through traditional auctions. Though network-based auctions (e.g., Internet based auctions) provide significant advantages, the reliance on third party auction providers has limited a seller's control in a number of ways including through rules on the conformance of auction procedures and the loss of control over restricting auction participation and bidding.

Third party auction providers provide a large scale e-commerce community portal that brings together large numbers of buyers and sellers who gather to trade in goods and services. Everyday, millions of items across thousands of categories are available on third party auction providers, for sale by auction and for a fixed price, enabling trade on a local, national, and international basis with customized Internet Web sites in markets around the world. These third party auction providers may provide auction services for the seller as well as access to a ready pool of potential buyers but in exchange they may require a seller to conform their auctioning processes and procedures. In addition, a third party auction provider typically takes a fee that may be fixed or proportional to the value of the auctioned goods and/or services. In both cases, the seller loses some degree of control over the auction process in exchange for using the third party auction service.

In addition to the limitations on auction procedures and processes imposed by a third party auction provider, a business may not be able to make maximum use of its business information in providing and generating auctions through a third party auction service. Businesses have typically kept their information, including information regarding their assets and inventory they wish to sell or auction off, in database systems that are part of their corporate information systems. Conventional systems provide limited linking between these business information management systems and online Web auction services and, therefore, manual involvement with the Web auction service is required for each auction or sales posting conducted. These problems may be overcome and the limitations of third party auction services avoided by providing auction services through a seller's own e-commerce site. In this manner, full advantage may be taken by linking a seller's business information management systems with its e-commerce site allowing greater automation of the auction submission, tracking, and post-auction processing. An integrated internal auction system solves these problems in a novel manner providing considerable advantages to a seller. In this manner, a seller may be able to provide a customer auction information and notification in the seller's product catalog through a seller's e-commerce site in an internal auction system.

### BRIEF DESCRIPTION OF THE DRAWINGS

FIG. 1 is a diagram illustrating the integrated internal auction system according to one embodiment of the present invention.

FIG. 2 is a flowchart illustrating the process for displaying an auction indicator in a product catalog on a seller e-commerce network site of an integrated internal auction system according to one embodiment of the present invention.

FIG. 3 is a flowchart illustrating an example process for navigating to an auction from a product catalog displayed on a seller e-commerce network site using an auction indicator in the displayed product catalog in an integrated internal auction system according to one embodiment of the present invention.

FIG. 4a is an example database table for storing auction information in an integrated internal auction system and associating an auction with a product according to one embodiment of the present invention.

FIG. 4b is an example database table for storing an association or linking of an auction with a product in an integrated internal auction system according to one embodiment of the present invention.

FIG. 5 is a block diagram illustrating the platform on which the method and system for displaying auction information in a product catalog on a seller e-commerce network site in an integrated internal auction system operates according to one embodiment of the present invention.

### DETAILED DESCRIPTION

According to one embodiment of the present invention, a method and system for providing an integrated auction capability through a seller e-commerce network site is provided through an integrated internal auction system. The integrated internal auction system may include a seller-side application to allow a seller to generate an auction using an available seller business information management system, publish the auction on a seller e-commerce network site, process an auction winner, and monitor ongoing auctions in a manner leveraging a seller's existing business information management systems and e-commerce network sites. The integrated internal auction system may also include a buyer-side application to provide buyer functionality on a seller e-commerce network site to view and participate in published auctions, to monitor auctions and bidding, and to perform any necessary checkout procedures on winning an auction. In particular, the integrated internal auction system may allow a buyer/customer using a seller e-commerce network site to view auction information (e.g., auction status) and link (i.e., navigate) to an auction from a product catalog in a seller business information management system. The integrated internal auction system may serve as the conduit between seller's business information management system(s) and e-commerce site(s) while providing seller and/or buyer functionality to implement an integrated auction capability under the seller's internal control (i.e., without using an external third party auction provider or facilitator).

In one embodiment of the present invention, a buyer may be presented with auction information in a product catalog made available over a seller e-commerce network site. The product catalog may contain product and/or service information (for products and/or services offered to the buyer) from one or more seller business information management systems that may, for example, be displayed to the buyer in a table format. The auction information may be linked with the product catalog by the internal auction application in the integrated internal auction system according to one embodiment of the present invention. The inclusion of auction information in the product catalog allows for the rapid and convenient notification of available auctions to a buyer. In this manner, a buyer may be made aware of existing auctions and their status while browsing the product catalog. In one embodiment of the present invention, the auction information in the product may be linked to an auction and the buyer may simply select by conventional means (e.g., clicking on an icon or link) the auction information resulting in the navigation of the seller e-commerce network site display to the auction for the buyer. This provides a convenient method to notify the buyer regarding auctions for a product and to navigate the buyer to the appropriate auction.

In one embodiment of the present invention, an auction indicator (auction information) may be included for each product which has an associated auction in which the buyer is allowed to participate. For example, if an entry in the product catalog being displayed to the buyer over the seller e-commerce network site is a “Model M-09 Flatscreen” monitor and an auction for the product exists in which the buyer is authorized to participate, an icon or other indicator (i.e., auction information) may be included in the product catalog entry for the flat screen monitor to indicate that an auction exists. If the buyer is not authorized to participate in an auction, auction information may not be displayed for that product to the buyer. However, if there are multiple auctions for the product and the buyer is allowed to participate in at least one of the auctions, auction information may be indicated in the product catalog according to this embodiment.

In another embodiment of the present invention, the auction information included in the product catalog not only notifies the buyer of an auction for a product but it may also notify the buyer of the auction status. For example, a graphical icon such as an auctioneer's gavel may be used to indicate both the existence of an auction and its status. A raised gavel (hammer at top with the gavel vertical to the plane) according to this example may be used to indicate that an auction exists but has not yet opened for the product (i.e., the auction has not yet started). This may occur where an auction is published but the start date and time have not yet been reached. A dropping gavel (gavel at 45 degrees from the plane) may be used according to this example to indicate an auction that has already begun and is currently ongoing. A fallen gavel (gavel horizontal with the plane) may be used according to this example to indicate an auction that has closed and for which no more bids may be taken. In a situation where more than one auction exists for a product in the product catalog, a single auction indicator may be used to indicate all the auctions cumulatively for the product. Where a graphical icon or other means such as the gavel described above is used to indicate the auction status, a hierarchy of status may be used to determine the status displayed. For example, if ongoing auctions are given the highest value in this status hierarchy and if only one of the auctions for the product is currently ongoing, the ongoing status is used to indicate that at least one ongoing auction exists among the multiple auctions. If a published but not yet ongoing status is the next in the status hierarchy and no ongoing auctions for a product exist, the published status is used if at least one published but not ongoing auction exists for the product. In an alternative embodiment, a separate auction indicator (e.g., a gavel) may be displayed for each auction. This may become cumbersome, cluttering the product catalog display so the auction indicators may be reduced in size according to this embodiment when multiple auctions exist for a product.

In one embodiment of the present invention, the auction information may be linked to the auction and selecting the auction information using conventional selection means (e.g., clicking on the auction information) may navigate the buyer to the auction. Using the above example where the auction information included in the product catalog is a graphical icon indicating that an auction exists and perhaps indicating auction status, clicking on or otherwise selecting the graphical icon navigates the buyer to the associated auction for the product. If the auction information is being used to indicate more than one auction for the product, selecting the auction information in order to navigate to the auction may result in an auction listing being displayed containing all the associated auctions for the product. The buyer may then select an auction from this listing to navigate to a particular auction. Though the embodiments discussed herein generally refer to a product catalog and an auction for a product, it should be understood that the catalog may contain services in addition to or instead of products and an auction may be conducted for products and/or services.

According to one embodiment of the present invention, the internal auction application links a seller e-commerce site (i.e., a seller network site) with a seller's existing business information management system(s) in order to provide auction services to buyers (customers) through the seller e-commerce site. A seller e-commerce site according to this embodiment may be any electronic business presence that a seller provides to potential buyers. For example, a seller Web site on the Internet that offers information on or purchase of seller's products can be considered a seller e-commerce site. A seller business information management system according to this embodiment may be any seller information system containing product and/or sales and marketing information that may be used in the provision of products to a buyer. For example, a seller inventory system that tracks the availability of seller products may be considered one form of many potential seller business information management systems. A seller business information management system implies business applications using a programming and/or program interface working with a database to accomplish one or more tasks. However, according to this embodiment a seller business information management system may be considered either the database and the interface to access the database by itself as well as this database and associated interface in conjunction with associated applications. The internal auction application according to this embodiment provides the functionality to implement the auctioning of seller products (i.e., products sold by the seller) on the seller e-commerce site in conjunction with using at least one of the seller business information management systems.

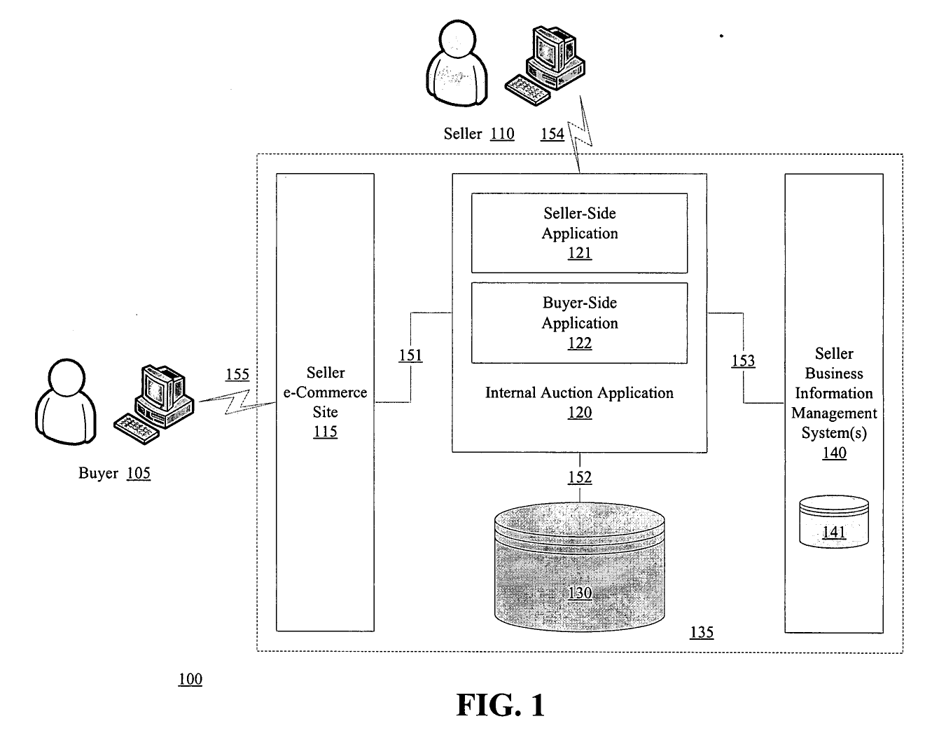

FIG. 1 is a diagram illustrating the integrated internal auction system according to one embodiment of the present invention. A seller 110 may create an auction using an internal auction application 120 residing on the seller information technology hardware environment 135. For example, the internal auction application 120 may consist of one or more software applications, programs, modules, procedures, or other computer code to include firmware and may additionally include data that resides on one or more servers, computers, or other hardware platforms that make up the seller information technology hardware environment 135. The internal auction application 120 may be conceptualized as containing a seller-side application 121 handling the seller interaction 154 with the integrated internal auction system 100 through the internal auction application 120. The seller-side application 121 may provide the functionality allowing the seller 110 to create, monitor, and manage one or more auctions. The internal auction application 120 may also be conceptualized as containing a buyer-side application 122 handling the buyer interaction 155 with the integrated internal auction system 100 allowing buyer interaction 155 with the internal auction application 120 and the seller business information management system(s) 140 through a seller e-commerce site 115. The buyer-side application 122 may provide the functionality allowing the buyer 105 to view auctions, participate in active auctions, monitor auctions, and perform the checkout process on won auctions. Though conceptually the functionality provided by the seller-side application 121 and the buyer-side application 122 of the internal auction application 120 are different, both may share data sets, procedures, libraries, and other elements of software code or data. In one embodiment of the present invention, all the elements of the internal auction application 120 may either be contained in both the conceptual subsets—seller-side application 121 and buyer-side application 122—or in an alternative embodiment the internal auction application 120 may contain additional elements of software code and/or data in addition to these conceptual subsets 121, 122. The internal auction application 120 may use data contained in a seller's business information management system(s) 140 and/or stored in a local database 130 for the internal auction application 120. This local database 130 may be considered part of the internal auction application 120 in this embodiment of the present invention even if the database is stored separately in a memory or storage system.

An internal auction application 120 may communicate 152 with the local database 130; communicate 153 with the seller business information management system(s) 140; and communicate 151 with the seller e-commerce site 115 using a communication network that is part of the seller information technology hardware environment 135. For example, the seller e-commerce site 115, internal auction application 120, local database 130, and business information management system(s) 140 may be located on servers or other computers that are part of a communication network—such as a local area network (LAN) or wide area network (WAN)—controlled by the seller. In an alternative embodiment, the seller information technology hardware environment 135 may include a communication network that is shared by the seller with other network users. For example, the seller e-commerce site 115, internal auction application 120, local database 130, and business information management system(s) 140 may be located on servers or other computers that are part of at least one internal seller communication network (e.g., a LAN and/or WAN) as well as a shared (i.e., shared by seller with other non-seller related entities) communication network such as the Internet. In either embodiment regardless of the network used for communication between the elements of the integrated auction system 100, seller communication 154 and buyer communication 155 with the integrated auction system 100 may occur over an external network (i.e., a network external to the seller and not under the seller's direct control), such as for example, the Internet. In an alternative embodiment, seller and buyer communication 154, 155 with the integrated auction application 100 may occur over a seller-controlled network (such as a seller-controlled wide area sales network) and/or may involve a combination of at least one seller-controlled network and at least one external network.

The integrated auction system 100 integrates a seller business information management systems(s) 140, which serves as a backend system(s), with a seller e-commerce site 115, serving as a front-end system, using an internal auction application 120 in order to provide auction services to the seller 110 and the buyer 105 according to one embodiment of the present invention. A seller business information management system 140 is a an application with at least one associated database 141 typically using a database management system (DBMS) that provides data storage and associated programming support for that data (e.g., a query system such as an SQL editor, optimization routines, program interfaces). For example, a seller may have an inventory control system 140 with its own inventory database 141 as one example of a business information management system 140. The business information management system(s) 140 may contain product information and availability information used in generating an auction and performing order generation to fulfill a winning bidder's order according to one embodiment of the present invention. The seller e-commerce site 115 allows a buyer 105 to participate in an auction over a communication network. For example, a seller Web site on the Internet offering goods and/or services (electronic commerce) is one example of a seller e-commerce site 115. An auction in the integrated auction system 100 is made available to the buyer 105 through the seller e-commerce site 115 which may serve as the buyer portal to the integrated auction system 100 according to one embodiment of the present invention. The seller 110 creates and manages auctions through the internal auction application 120 which integrates 153 information from the business information management system(s) 140 and provides the interaction processing 151 with the buyer 105 through the seller e-commerce site 115.

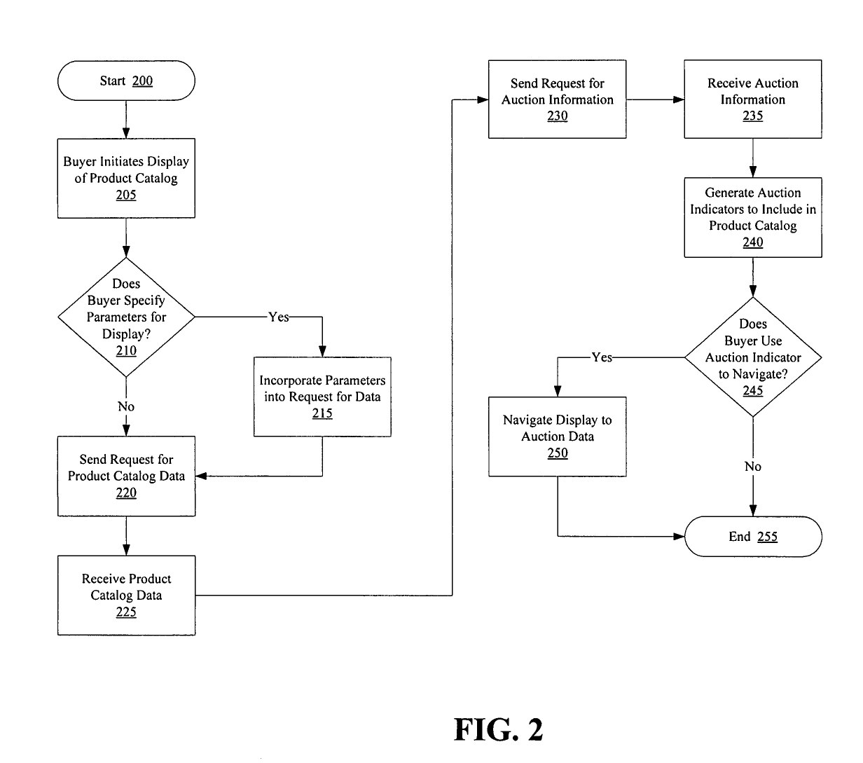

FIG. 2 is a flowchart illustrating the process for displaying an auction indicator in a product catalog on a seller e-commerce network site of an integrated internal auction system according to one embodiment of the present invention. The process begins 200 when a buyer 105 using a seller e-commerce network site 115 initiates the display of a product catalog by choosing an option on the site 115 generating the display. For example, a buyer 105 may browse products that the seller 110 is making available for sale through the e-commerce network site 115. The buyer 105 may be provided with one or more options on the seller e-commerce site 115 to limit or focus the display of the product catalog information. For example, a search feature may be included allowing the buyer to narrow or refine the product data displayed. In another example, product categories may be included which the buyer 105 may select limiting the displayed product catalog information to those products within the selected category. In a second step 210, a buyer may specify parameters for the display of the product catalog such as, for example, search parameters. If these parameters are specified, they are incorporated into a request for the product catalog data in a conditional third step 215 of this process. The request is generated by the seller e-commerce network site 115 or an application controlling the display on the seller e-commerce network site 115 and is sent to at least one seller business information management system 140 in a fourth step 220 in this process. The seller business information management system 140 receives the request, processes the request, and returns the requested product catalog data to the seller e-commerce site 115 or the application controlling the display on the seller e-commerce site 115. If search or other narrowing parameters are included in the request 215, these parameters are used by the seller business information management system to correspondingly limit or broaden the retrieved product catalog information. The seller e-commerce network site 115 or the application controlling the display on the seller e-commerce network site 115 receives the retrieved product catalog information in a fifth step 225 in the process. In conjunction with or following the request for the product catalog information, a request is also sent to the internal auction application 120 for corresponding auction information in a sixth step 230 of this process according to one embodiment of the present invention. In this sixth step 230, the products to be retrieved and/or a search specification are included in the request in order for the internal auction application 120 to retrieve corresponding auction information for the products. In a seventh step 235, the internal auction application retrieves the corresponding auction information for the product data included in the request 230. In one embodiment, the retrieved auction information is returned to the seller e-commerce site 115 for processing. In another embodiment, the internal auction application performs the necessary processing of the retrieved auction data 235. In an eighth step 240, the retrieved auction data is processed to generate an appropriate auction indicator for the product catalog and/or to provide any appropriate link for the auction indicator according to this embodiment. For example, the auction indicator may indicate the status of an auction as previously described and the auction indicator may need to be generated to reflect the appropriate auction status. In another example where a single auction indicator may be used to indicate several auctions for a product, this generating step 240 may need to determine the appropriate status considering the status of all the auctions indicated as previously discussed. In another embodiment of the present invention, a hyperlink may be associated with an auction indicator during this step 240 facilitating navigation to the auction on the seller e-commerce site 115 also as previously discussed.

The generated auction indicators may then be included in the product catalog data 240. If the auction indicators are generated by the internal auction application 120, the generated indicators with any hyperlinks are returned to the seller e-commerce site 115 or to the application controlling the display on the seller e-commerce site 115. The auction indicators may now be included in the displayed product catalog data. If the buyer 105 does not use these auction indicators to navigate to an auction or the auction indicators do not include hyperlinks, the buyer 105 cannot use the auction indicators to navigate to the auctions in a ninth step 245 and the process of including auction information into product catalog is concluded 255. If the buyer does use the auction indicators to navigate to an auction in the ninth step 245, the display of the auction data may be presented to the buyer in a new or the same screen on the seller e-commerce site in a tenth step 250 in this process according to this embodiment. The process may conclude 255 with after the display of the auction indicators and the navigation of the buyer.

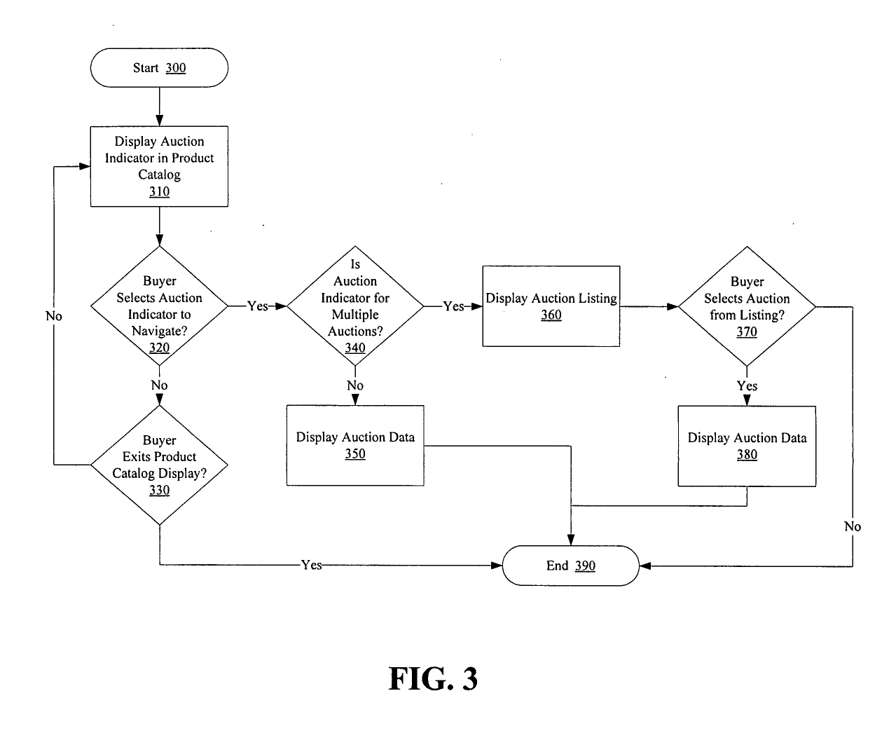

FIG. 3 is a flowchart illustrating an example process for navigating to an auction from a product catalog displayed on a seller e-commerce network site using an auction indicator in the displayed product catalog in an integrated internal auction system according to one embodiment of the present invention. In a first step 310, the example process begins 300 by displaying an auction indicator to a buyer 105 in the product catalog. The auction indicator may indicate an auction status and may incorporate a hyperlink or other navigation means to allow a buyer to quickly navigate to the associated auction(s) by selecting the auction indicator. One example process for including an auction indicator in a product catalog was described along with FIG. 2 above. In a second step 320 of this process, the buyer 105 may select (by conventional means such as, for example, clicking on the auction indicator) an auction indicator in the product catalog in order to navigate to the auction according to this embodiment. If the buyer 105 does not select an auction indicator, the buyer may continue to view the product catalog or may decide to exit from the product catalog display 330 thus concluding the process 390. If the buyer selects an auction indicator 320, a determination may need to be made in a third step 340 whether or not the indicator represents a single auction or multiple auctions. If the auction indicator represents a single auction 340, the buyer is navigated to a display of data for that auction 350 and the process of navigating to an auction from a product catalog using an auction indicator concludes 390.

If the auction indicator represents multiple auctions 340, an auction listing may be displayed 360 containing the auctions represented by the indicator in a table format. The buyer may examine the auctions and auction data in the auction listing and may select an auction 370 from the listing to view its details. If the buyer 105 selects an auction from the listing to view 370, the buyer is navigated to a display of data for that auction 380 and the process of navigating to an auction from a product catalog using an auction indicator concludes 390. If the buyer decides not to view an auction from the auction listing 370, the process also concludes without navigating the buyer to a display of data for a specific auction.

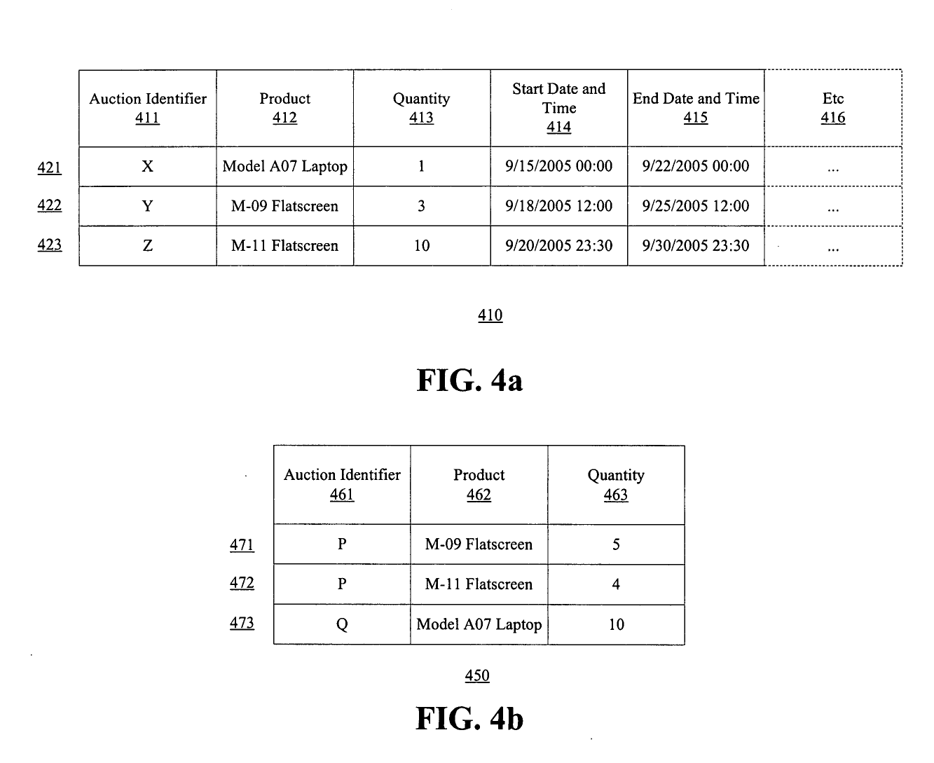

FIG. 4a is an example database table for storing auction information in an integrated internal auction system and associating an auction with a product according to one embodiment of the present invention. The auction data table 410 may include any number of rows from zero rows to multiple rows 421-423 of data with each row in the table providing the details for a single auction in an integrated internal auction system 100 as shown in FIG. 1. The rows 421-423 of the auction data table 410 show a simplified example of the data that may exist for an auction according to one embodiment of the present invention.

The auction data table 410 may include a number of rows each describing one auction. An auction may be identified using a unique auction identifier stored in the auction identifier column 411 of the auction data table 410. For example in the first row 421 of the auction data table 410 the auction identifier is “X” while in the second row 422 it is “Y” and in the third row 423 it is “Z”. A product may be identified using a unique product identifier stored in the product column 412 of the auction data table 410. For example in the first row 421, the product is “Model A07 Laptop”. In addition to the product 412, an auction data table may also include a quantity column 413 (or lot size column) indicating the quantity of the product included in the auction. Additional auction parameters in the auction data table 410 may include a start date and time column 414 specifying the date and time the auction is scheduled to start. For example, in the first row 421 of the auction data table 410 the specified start date is Sep. 15, 2005 with midnight (“00:00” using a 24-hour clock) as the start time. In addition to a start date and time column 414, an end date and time column 415 may also be included in the auction parameters indicating when an auction will end. For example in the first row 421 of the auction data table 410, the auction will conclude on Sep. 22, 2005 at midnight. The Etc. column 416 is shown to indicate that other columns of data may also be included for the auction in the auction data table 410. For this reason, the Etc. column 416 is shown in dashed lines.

FIG. 4b is an example database table for storing an association or linking of an auction with a product in an integrated internal auction system according to one embodiment of the present invention. The auction-to-product table 450 shown is an alternative embodiment of the present invention from the auction data table 410 shown in FIG. 4a and may be used where there are multiple products and/or services for an auction. In this embodiment, an auction data table 410 similar to the one shown in FIG. 4a is used to store the auction information but no product 412 or quantity 413 columns are included in the table. Instead, an auction is associated or linked to a product and/or service using the separate table 450. In this manner an auction may include multiple products and/or services in a normalized manner with only one entry of auction parameter information in the auction data table 410. In the first row 471 of the auction-to-product table 450, auction “P” 461 includes 5 units 463 of “M-09 Flatscreen” product 462. A second row 472 in the auction-to-product table 450 indicates that auction “P” 461 also includes 4 units 463 of “M-11 Flatscreen” product 462. A third row 473 in the auction-to-product table 450 indicates that auction “Q” 461 includes 10 units 463 of “Model A07 Laptop” product 462.

FIGS. 4a and 4b are included to show how an auction may be associated with a product in the either the internal auction application 120 database 130 or in a seller business information management system database 141 according to one embodiment of the present invention. The association of the auction to the product is used, as described in FIG. 2, to determine which entries in the displayed product catalog require an auction indicator according to this embodiment and what auction, if any, will the auction indicator be linked to.

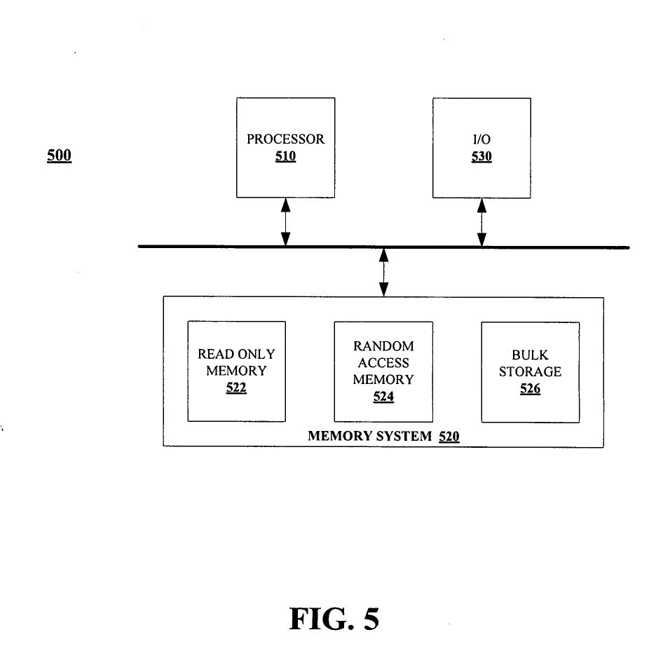

FIG. 5 is a block diagram illustrating the platform on which the method and system for displaying auction information in a product catalog on a seller e-commerce network site in an integrated internal auction system operates according to one embodiment of the present invention. Functionality of the foregoing embodiments may be provided on various computer platforms executing program instructions. One such platform 500 is illustrated in the simplified block diagram of FIG. 5. There, the platform 500 is shown as being populated by a processor 510, a memory system 520 and an input/output (I/O) unit 530. The processor 510 may be any of a plurality of conventional processing systems, including microprocessors, digital signal processors and field programmable logic arrays. In some applications, it may be advantageous to provide multiple processors (not shown) in the platform 500. The processor(s) 510 execute program instructions stored in the memory system. The memory system 520 may include any combination of conventional memory circuits, including electrical, magnetic or optical memory systems. As shown in FIG. 5, the memory system may include read only memories 522, random access memories 524 and bulk storage 526. The memory system not only stores the program instructions representing the various methods described herein but also can store the data items on which these methods operate. The I/O unit 530 would permit communication with external devices (not shown).

What is claimed is:

1. A method for displaying auction information in a product catalog on seller e-commerce network site in an internal auction system, comprising:
receiving a product catalog request from a buyer;
sending a request for the product catalog to a seller business information management system as a function of the received product catalog request;
receiving the product catalog as a function of the sent request;
sending an auction request to an internal auction application as a function of the received product catalog;
receiving an auction data item as a function of the sent auction request;
generating an auction indicator as a function of the received auction data item; and
displaying the auction indicator in the product catalog as a function of the received product catalog and the generated auction request.

2. The method according to claim 1, the sending an auction request step further comprising:
sending an auction request to an internal auction application as a function of the received product catalog request;

3. The method according to claim 1, wherein the generated auction indicator includes a hyperlink to at least one of an auction and an auction listing.

4. A system for displaying auction information in a product catalog on seller e-commerce network site in an internal auction system, comprising:
a memory system;
an input/output unit; and
a processor, wherein the processor is adapted to:
(i) receive a product catalog request from a buyer;
(ii) send a request for the product catalog to a seller business information management system as a function of the received product catalog request;
(iii) receive the product catalog as a function of the sent request;
(iv) send an auction request to an internal auction application as a function of the received product catalog;
(v) receive an auction data item as a function of the sent auction request;
(vi) generate an auction indicator as a function of the received auction data item; and
(vii) display the auction indicator in the product catalog as a function of the received product catalog and the generated auction request.

5. A computer readable medium including instructions adapted to execute a method for displaying auction information in a product catalog on seller e-commerce network site in an internal auction system, the method comprising:
receiving a product catalog request from a buyer;
sending a request for the product catalog to a seller business information management system as a function of the received product catalog request;
receiving the product catalog as a function of the sent request;
sending an auction request to an internal auction application as a function of the received product catalog;
receiving an auction data item as a function of the sent auction request;
generating an auction indicator as a function of the received auction data item; and
displaying the auction indicator in the product catalog as a function of the received product catalog and the generated auction request.
